(19) United States
(12) Patent Application Publication
(10) Pub. No.: US 2007/0188981 A1
(43) Pub. Date: Aug. 16, 2007

(54) Solid electrolytic capacitor and method of manufacturing solid electrolytic capacitor

(75) Inventors: Kazuhiro Takatani, Takatsuki (JP); Kazumi Kurooka, Fujiidera (JP); Tomoko Omori, Hirakata (JP); Mutsumi Yano, Hirakata (JP); Takashi Umemoto, Hirakata (JP); Hiroshi Nonoue, Hirakata (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi (JP)

(21) Appl. No.: 11/711,050

(22) Filed: Feb. 27, 2007

(30) Foreign Application Priority Data
Feb. 28, 2006 (JP) JP2006-054120
Dec. 28, 2006 (JP) JP2006-356567

(51) Int. Cl. H01G 9/00

(52) U.S. Cl. 361/523

(57) ABSTRACT

A solid electrolytic capacitor includes an anode and a dielectric layer. The anode is made of niobium or a niobium alloy. The dielectric layer is made of niobium oxide formed on the niobium or the niobium alloy. The niobium oxide has a feature that a full width at half maximum of a peak of an Mz ray of characteristic X-rays of niobium is 0.98 Å or more. The characteristic X-rays are emitted when the niobium oxide is irradiated with an electron beam.

### CROSS REFERENCE TO RELATED APPLICATIONS

This application is based upon and claims the benefit of priority from prior Japanese Patent Application No. 2006-54120, filed on February 28; and prior Japanese Patent Application No. 2006-356567, filed on December 28; the entire contents of which are incorporated herein by reference.

### BACKGROUND OF THE INVENTION

1. Field of the Invention

This present invention relates to a solid electrolytic capacitor and a method of manufacturing the solid electrolytic capacitor, the solid electrolytic capacitor including an anode made of niobium or a niobium alloy, and a dielectric layer made of a niobium oxide formed on a surface of the niobium or the niobium alloy.

2. Description of the Related Art

In recent years, performance of a personal computer has been improved due to an increasing in the frequency of a CPU. With the improvement, a solid electrolytic capacitor having a high capacitance, and concurrently, a low equivalent series resistance (abbreviated as an ESR) has been desired. Accordingly, as a material for an anode of a solid electrolytic capacitor capable of achieving a high capacitance, niobium has been attracting attention. This is because the niobium has a dielectric constant, which determines a capacitance, 1.8 times higher than that of tantalum conventionally used as a material for an anode of a solid electrolytic capacitor.

However, in the case of a solid electrolytic capacitor including an anode made of niobium or a niobium alloy and a dielectric layer made of niobium oxide, there is a problem that the amount of leakage current increases, since a large number of defects exist in the niobium oxide. When the amount of defects, which is crystalline oxide, is small in the niobium oxide, the amount of leakage current is reduced. However, when the amount of crystalline oxide is large in the niobium oxide, the amount of leakage current becomes large. Hence, a solid electrolytic capacitor using an anode made of niobium or a niobium alloy has not been put into practical use. Accordingly, various kinds of techniques which reduce leakage current have been studied.

For example, in Japanese Patent Publication No. Hei 7(1999)-153650, disclosed is a solid electrolytic capacitor manufactured by performing anodization in a phosphoric acid solution when niobium oxide is formed on a surface of an anode. Thereby, the amount of leakage current can be reduced.

Moreover, in Japanese Patent Publication No. Hei 11(2003)-329902, disclosed is another solid electrolytic capacitor. In this solid electrolytic capacitor, nitride is formed on a surface of niobium metal, and then niobium oxide is formed thereon. This makes it possible to reduce leakage current, and to restrain the change of an electrostatic capacitance before and after a reflow soldering.

However, with the solid electrolytic capacitors described above, the amount of leakage current cannot be reduced to a level where the solid electrolytic capacitors can be put into practical use.

### SUMMARY OF THE INVENTION

A first aspect of the present invention is a solid electrolytic capacitor including an anode and a dielectric layer. The anode is made of niobium or a niobium alloy. The dielectric layer is made of niobium oxide and formed on a surface of the niobium or the niobium alloy. In the solid electrolytic capacitor, a full width at half maximum of the peak of an Mz ray of characteristic X-rays of niobium, which are emitted when the niobium oxide is irradiated with an electron beam, is 0.98 Å or more. Here, the Mz ray is a characteristic X-ray emitted when an electron in the M shell around a nucleus moves to a lower energy level.

In the first aspect of the present invention, it is preferable that the full width at half maximum of the peak of the Mz ray of the characteristic X-rays of niobium is 1.00 Å or more.

A second aspect of the present invention is a method of manufacturing a solid electrolytic capacitor. The method include the step of forming a dielectric layer by anodizing an anode made of niobium or a niobium alloy in a solution selected among a formic acid solution, a tartaric acid solution and a citric acid solution.

In the second aspect of the present invention, it is preferable that the formic acid solution, the tartaric acid solution or the citric acid solution, which is used in the step of forming the dielectric layer, has a concentration of 0.05 wt % or more.

### BRIEF DESCRIPTION OF THE DRAWINGS

FIG. 1 is a view showing a configuration of a solid electrolytic capacitor of the present invention.

FIG. 2 is a view showing a peak of an Mz ray of characteristic X-rays of niobium of a solid electrolytic capacitor of Example 1.

### DETAILED DESCRIPTION OF THE PREFERRED EMBODIMENTS

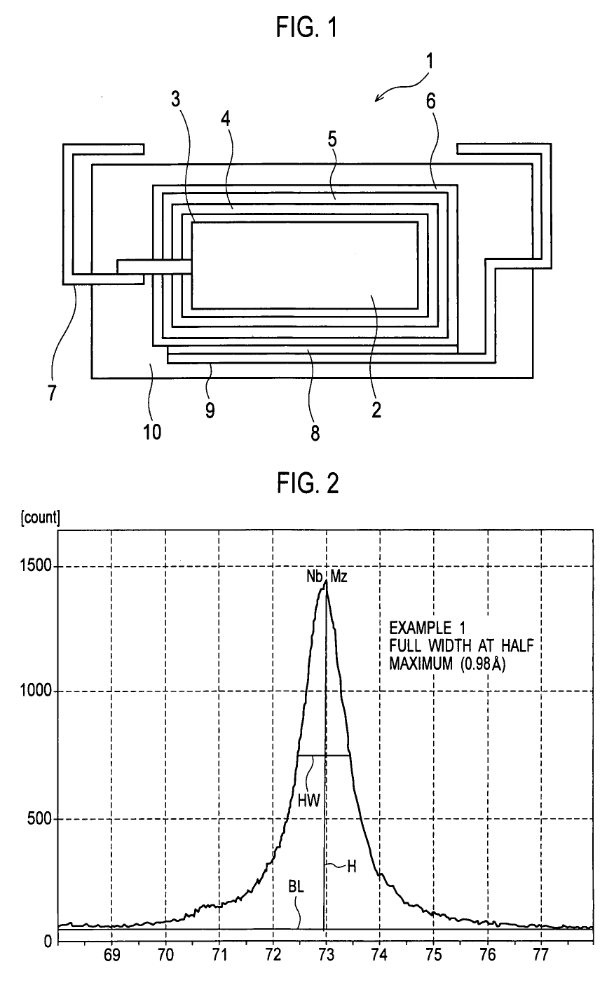

Embodiments of the present invention are described below with reference to the accompanying drawings. FIG. 1 is a view showing a configuration of a solid electrolytic capacitor of the present invention.

As shown in FIG. 1, a solid electrolytic capacitor 1 includes an anode 2, a dielectric layer 3, a conductive polymer layer 4, a carbon layer 5, a silver paste layer 6 and mold resin 10.

The anode 2 is made of a porous sintered body obtained by sintering powder particles of niobium or a niobium alloy that is valve metal (metal having valve action). As the niobium alloy, alloys of niobium with aluminum, vanadium, hafnium, zirconium, titanium or tantalum may be employed.

The dielectric layer 3 is made of niobium oxide (Nb₂O₅), and is formed on surfaces of the particles of niobium or a niobium alloy forming the anode 2. In the present invention, the niobium oxide forming the dielectric layer 3 is formed so that the full width at half maximum of the peak of an Mz ray of characteristic X-rays of niobium is 0.98 Å or more. The characteristic X-rays of niobium are emitted when the niobium oxide is irradiated with an electron beam. Furthermore, it is preferable that the full width at half maximum of the peak of the Mz ray of the characteristic X-rays of niobium forming the dielectric layer 3 is 1.00 Å or more.

The conductive polymer layer 4 functions as a cathode, and is made of a conductive polymer such as polypyrrole and polythiophene. The conductive polymer layer 4 is formed so as to covers the anode 2 and the dielectric layer 3. The carbon layer 5 is made of carbon paste, and is formed so as to cover the conductive polymer layer 4. The silver paste layer 6 is made of a mixture of silver particles and an organic solvent, and is formed so as to cover the carbon layer 5. The carbon layer 5 and the silver paste layer 6 function as a cathode current collector. A cathode terminal 9 for connecting the outside is connected to the silver paste layer 6 via a conductive adhesive 8. Moreover, an anode terminal 7 is connected to the anode 2. The mold resin 10 is provided so as to cover the above-described members, except the anode terminal 7 and the cathode terminal 9.

Next, a method of manufacturing the solid electrolytic capacitor 1 is described.

First, in a process of manufacturing an anode, powder particles made of niobium or a niobium alloy are mixed with a binding agent and formed into compound. Thereafter, the formed compound is sintered. Thereby, an anode 2 made of niobium or a niobium alloy is manufactured. Next, in a process of forming a dielectric layer, the anode 2 is anodized in a state where the anode 2 is immersed in a formic acid solution, a tartaric acid solution or a citric acid solution. Thereby, the dielectric layer 3 made of niobium oxide is formed on the surfaces of the powder particles of niobium or a niobium alloy. Incidentally, a formic acid solution, a tartaric acid solution or a citric acid solution of a concentration of 0.05% or higher by weight be preferably used in the process of forming a dielectric layer.

Next, in a process of manufacturing a solid electrolytic capacitor, the conductive polymer layer 4, the carbon layer 5 and the silver paste layer 6 are sequentially manufactured so as to cover the dielectric layer 3. Lastly, the cathode terminal 9 is bonded to the silver paste layer 6 with the conductive adhesive 8 interposed therebetween, and the anode terminal 7 is connected to the anode 2. Thereafter, a mold resin layer 10 is formed, thus completing the solid electrolytic capacitor 1.

In the solid electrolytic capacitor of the present invention, the dielectric layer 3 is formed where an amount of crystalline niobium oxide is small, and the full width at half maximum of the peak of the Mz ray of the characteristic X-rays of niobium is 0.98 Å or more, the characteristic X-rays are emitted when the niobium oxide is irradiated with an electron beam. More preferably, the full width at half maximum is 1.00 Å or more. Therefore, the leakage current is reduced.

### EXAMPLES

Hereinafter, described are Experiments conducted to verify an effect described above the leakage current are reduced.

### (Experiment 1)

First, a description is given of a first experiment. The first experiment was conducted to verify an effect that the leakage current is reduced by forming a dielectric layer having a full-width half maximum of about 0.98 Å by using formic acid.

First, descriptions are given of methods of manufacturing solid electrolytic capacitors of Examples 1 to 8 and Comparative Examples 1 to 3, which were manufactured for conducting experiments, respectively.

### Example 1

In a process of manufacturing an anode, powder particles of pure niobium metal and a binding agent were mixed and formed into compound. Then, the formed compound was sintered at a temperature of about 1150° C. Thereby, an anode based on niobium formed of a porous sintered body in which niobium particles were welded one another was manufactured.

Subsequently, in the process of manufacturing a dielectric layer, the anode made of the niobium base body was anodized, at a constant voltage of about 40 V for about 10 hours in a formic acid solution of about 0.05 wt % which temperature was maintained at about 40° C. Thereby, a dielectric layer made of niobium oxide was formed on the surface of the niobium powder particles forming the anode.

Next, in the process of manufacturing a solid electrolytic capacitor, by employing a technique using chemical polymerization, electrolytic polymerization and so on, a conductive polymer layer made of polypyrrole was manufactured so as to cover the dielectric layer. Furthermore, carbon paste and silver paste were sequentially applied, and thereby a carbon layer and a silver paste layer are formed. Subsequently, a cathode terminal is bonded to the silver paste layer with a conductive adhesive interposed therebetween. Moreover, an anode terminal is connected to the anode. Thereafter, a part other than end portions of the anode terminal and the cathode terminal is covered with mold resin, and thereby a solid electrolytic capacitor of Example 1 is manufactured.

### Example 2

A solid electrolytic capacitor of Example 2 was manufactured by employing the same manufacturing method as that of Example 1 except that a formic acid solution of about 0.075 wt % was used in the process of manufacturing a dielectric layer of the Example 1.

### Example 3

A solid electrolytic capacitor of Example 3 was manufactured by employing the same manufacturing method as that of Example 1 except that a formic acid solution of about 0.1 wt % was used in the process of manufacturing a dielectric layer of the Example 1.

### Example 4

A solid electrolytic capacitor of Example 4 was manufactured by employing the same manufacturing method as that of Example 1 except that a formic acid solution of about 0.2 wt % was used in the process of manufacturing a dielectric layer of the Example 1.

### Example 5

A solid electrolytic capacitor of Example 5 was manufactured by employing the same manufacturing method as that of Example 1 except that a formic acid solution of about 0.5 wt % was used in the process of manufacturing a dielectric layer of the Example 1.

### Example 6

A solid electrolytic capacitor of Example 6 was manufactured by employing the same manufacturing method as that of Example 1 except that a formic acid solution of about 0.7 wt % was used in the process of manufacturing a dielectric layer of the Example 1.

### Example 7

A solid electrolytic capacitor of Example 7 was manufactured by employing the same manufacturing method as that of Example 1 except that a formic acid solution of about 1.0 wt % was used in the process of manufacturing a dielectric layer of the Example 1.

### Example 8

A solid electrolytic capacitor of Example 8 was manufactured by employing the same manufacturing method as that of Example 1 except that powder particles made of niobium-aluminum alloy containing aluminum of about 0.5 wt % were used instead of the powder particles made of pure niobium metal used in the process of manufacturing an anode of the Example 1, and that a formic acid solution of about 0.1 wt % was used in the process of manufacturing a dielectric layer.

### Comparative Example 1

A solid electrolytic capacitor of Comparative Example 1 was manufactured by employing the same manufacturing method as that of Example 1 except that a phosphoric acid solution of about 0.1 wt % was used instead of the formic acid solution used in the process of manufacturing a dielectric layer of the Example 1.

### Comparative Example 2

In the process of manufacturing an anode in the above-described Example 1, after the anode made of a niobium base body was manufactured, nitrogen gas was then introduced into a sintering furnace where the anode was manufactured. Thereafter, a solid electrolytic capacitor of Comparative Example 2 was manufactured by employing the same manufacturing method as that of Example 1 except that, a nitride layer was formed on a surface of the anode in an atmosphere of nitrogen which temperature and pressure were set respectively at about 300° C. and about 300 Torr, and a dielectric layer made of niobium oxide was then formed in the process of manufacturing a dielectric layer.

### Comparative Example 3

A solid electrolytic capacitor of Comparative Example 3 was manufactured by employing the same manufacturing method as that of Example 1 except that a sulfuric acid solution of about 0.1 wt % was used instead of the formic acid solution in the process of manufacturing a dielectric layer of the above-described Example 1.

### (Measuring of Full Width at Half Maximum of Peak of Mz Ray of Characteristic X-Rays)

First, in the above-described process of manufacturing a dielectric layer, a cross-section of the niobium oxide forming the manufactured dielectric layer is analyzed by using an electron probe microanalyzer (abbreviated as an EPMA). To be precise, the peak of the Mz ray of the characteristic X-rays of niobium emitted when the niobium oxide was irradiated with an electron beam, was measured by using an electron probe microanalyzer (EPMA-1600) manufactured by Shimadzu Corporation. Conditions of the electron probe microanalyzer were set as follows.

Accelerating voltage: 10 kV

Diameter of irradiated beams: 50 μm

Beam current value: 0.04 μA

Analyzing crystal: PBST (Lead stearate)

Wave length at the start of analysis: 78 Å

Wave length at the end of analysis: 68 Å

Measurement step width: 0.098 Å

X-rays counting time: 1 second

Number of measuring points: 5 arbitrary points

The peak of the Mz ray was measured by the above described measuring method. The moving average of the peak of the measured Mz ray was obtained by using five points in total, the five points are one predetermined point and two sets of adjacent two points located on both sides of the predetermined point. Then, smoothing was applied to the peak of the measured Mz ray. FIG. 2 shows the peak of the Mz ray of Example 1 where the smoothing was applied. In FIG. 2, the vertical axis indicates counted number of characteristic X-rays, and the horizontal axis indicates wave lengths (Å) of the respective characteristic X-rays.

Subsequently, a base line BL is obtained as a background by connecting minimum values in two areas, the two areas are facing each other across the peak of the Mz ray. Then, the background is subtracted from the peak of the Mz ray. A full width at half maximum HW at a position whose height is half the height H of the peak after subtracting the background was obtained in each of Examples 1 to 8 and Comparative Examples 1 to 3.

### (Measuring of Leakage Current)

In each of Examples 1 to 8 and Comparative Examples 1 to 3, a voltage of about 5 V was applied to the solid electrolytic capacitor for about 20 seconds. Thereby, a leakage current was measured by using an ammeter connected to the outer side of the solid electrolytic capacitor.

Measured full width at half maximums and the corresponding leakage currents are shown in Table 1.

TABLE 1

| | Full width at | Leakage |
|---|---|---|
| | half maximum (Å) | current (μA) |
| Example 1 | 0.98 | 20 |
| Example 2 | 0.99 | 13 |
| Example 3 | 1.00 | 5 |
| Example 4 | 1.10 | 7 |
| Example 5 | 1.20 | 7 |
| Example 6 | 1.25 | 8 |
| Example 7 | 1.30 | 8 |
| Example 8 | 1.00 | 4 |
| Comparative | 0.95 | 120 |
| Example 1 | | |
| Comparative | 0.96 | 105 |
| Example 2 | | |
| Comparative | 0.97 | 90 |
| Example 3 | | |

As shown in Table 1, in each of Examples 1 to 8 of the present invention, by using the formic acid solution for forming the dielectric layer, the full width at half maximum was made about 0.98 Å or more. Accordingly, the leakage current became small, which is about 20 μA or less, in each of Examples 1 to 8. Moreover, in each of Examples 3 to 8 in which the full width at half maximum was made about 1.00 Å or more, the leakage current became further small, which is about 8 μA or less. On the other hand, in each of Comparative Examples 1 to 3 in which the dielectric layer was formed by using a phosphoric acid solution or a sulfuric acid solution, or in which the dielectric layer was formed after forming the nitride layer on the anode, the full width at half maximum became about 0.97 Å or less, and leakage current became so high, which is about 90 μA or more.

The reason can be considered as follows. In each of Examples 1 to 8 in which the full width at half maximum was about 0.98 Å or more, occurrence of defects in the niobium oxide was reduced. As a result, leakage current was reduced in each of Examples 1 to 8. On the contrary, in each of Comparative Examples 1 to 3, since a great number of defects, i.e. crystalline niobium oxide exist in niobium oxide, leakage current became large due to the defects.

Furthermore, the following can be seen from the experimental result on Example 8. Specifically, not only when using powder particles made of pure niobium metal, but also when using powder particles made of niobium-aluminum alloy, by forming a dielectric layer of the formic acid solution, it is possible to make the full width at half maximum to be about 1.00 Å, and leakage current can be reduced.

### (Experiment 2)

Next, Experiment 2 is described. Experiment 2 was conducted to verify the above-described effect can be obtained even when using a tartaric acid solution or a citric acid solution other than the formic acid solution in the process of manufacturing a dielectric layer.

### Example 9

A solid electrolytic capacitor of Example 9 was manufactured by employing the same manufacturing method as that of Example 1 except that a tartaric acid solution of about 0.1 wt % was used instead of the formic acid solution of about 0.05 wt % used in the process of manufacturing a dielectric layer of the above-described Example 1.

### Example 10

A solid electrolytic capacitor of Example 10 was manufactured by employing the same manufacturing method as that of Example 1 except that a citric acid solution of about 0.1 wt % was used instead of the formic acid solution of about 0.05 wt % used in the process of manufacturing a dielectric layer of the above-described Example 1.

### Example 11

A solid electrolytic capacitor of Example 11 was manufactured by employing the same manufacturing method as that of Example 1 except that a tartaric acid solution of about 0.05 wt % was used instead of the formic acid solution of about 0.05 wt % used in the process of manufacturing a dielectric layer of the above-described Example 1.

### Example 12

A solid electrolytic capacitor of Example 12 was manufactured by employing the same manufacturing method as that of Example 1 except that a citric acid solution of about 0.05 wt % was used instead of the formic acid solution of about 0.05 wt % in the process of manufacturing a dielectric layer of the above-described Example 1.

For each of those solid electrolytic capacitors of Experiments 9 to 12, the full width at half maximum of the peak of the Mz ray of the characteristic X-rays and leakage current were measured as in the case of Experiment 1. The results are shown in Table 2 below. Incidentally, for the purpose of comparison, measured values of Example 3, which was manufactured by using a formic acid solution of the same concentration (about 0.1 wt %) as those of Examples 9 and 10, and values of Example 1, which was manufactured by using a formic acid solution of the same concentration (about 0.05 wt %) as those of Examples 11 and 12 are also shown in Table 2.

TABLE 2

| | Full width at | Leakage |
|---|---|---|
| | half maximum (Å) | current (μA) |
| Example 3 | 1.00 | 5 |
| Example 9 | 1.01 | 8 |
| Example 10 | 1.03 | 8 |
| Example 1 | 0.98 | 20 |
| Example 11 | 0.99 | 24 |
| Example 12 | 1.00 | 26 |

As shown in Table 2, as in the case where formic acid were used, when manufacturing a dielectric layer made of niobium oxide by using the tartaric acid solution or the citric acid solution, the full width at half maximum was about 0.99 or more, and the leakage current became small, that it was not greater than about 26 μA.

It can be seen from these results that, even when a dielectric layer made of niobium oxide is manufactured by using not only the formic acid solution but also the tartaric acid solution or the citric acid solution having a concentration of 0.05 wt % or more, leakage current can be reduced.

Although the present invention is described in detail using Examples described above, it will be obvious to those skilled in the art that the present invention is not limited to the above-described embodiments described in the present description. Variations and modifications may be made on the present invention without departing from the spirit of the present and within the scope thereof. The present embodiments are therefore to be considered in all respects as illustrative and not restrictive.

What is claimed is:

1. A solid electrolytic capacitor comprising:
an anode made of niobium or a niobium alloy; and
a dielectric layer made of niobium oxide formed on a surface of the niobium or the niobium alloy; wherein,
a full width at half maximum of a peak of an Mz ray of characteristic X-rays of niobium, which are emitted when the niobium oxide is irradiated with an electron beam, is 0.98 Å or more.

2. The solid electrolytic capacitor according to claim 1, wherein the full width at half maximum of the peak of the Mz ray of the characteristic X-rays of niobium is 1.00 Å or more.

3. A method of manufacturing a solid electrolytic capacitor, comprising the step of:
forming a dielectric layer made of niobium oxide by anodizing an anode made of niobium or a niobium alloy in a solution selected from the group of a formic acid solution, a tartaric acid solution and a citric acid solution.

4. The method of manufacturing a solid electrolytic capacitor according to claim 3, wherein the formic acid solution, the tartaric acid solution or the citric acid solution, used in the step of forming the dielectric layer, has a concentration of 0.05 wt % or more.
